(19) United States
(12) Patent Application Publication
(10) Pub. No.: US 2012/0014601 A1
(43) Pub. Date: Jan. 19, 2012

(54) HANDWRITING RECOGNITION METHOD AND DEVICE

(75) Inventors: Shuhong Jiang, Shanghai (CN); Bo Wu, Shanghai (CN); Yadong Wu, Shanghai (CN); Wei Miao, Shanghai (CN); Ailong Li, Shanghai (CN)

(73) Assignee: JTEKT CORPORATION, Osaka-shi (JP)

(21) Appl. No.: 13/258,084

(22) PCT Filed: Jun. 23, 2010
(86) PCT No.: PCT/JP2010/061095

§ 371 Date: Sep. 21, 2011

(30) Foreign Application Priority Data
Jun. 24, 2009 (CN) 200910146369.2

(51) Int. Cl. G06K 9/34

(52) U.S. Cl. 382/173

(57) ABSTRACT

A handwriting recognition method and a handwriting recognition device are provided to recognize a character sequence continuously inputted by a user for convenience. The present method comprises steps of calculating various features of the inputted character sequence which include single character recognition accuracy features and space geometry features of different stroke combinations in the inputted character sequence, calculating segmentation reliabilities of respective stroke combinations in different segmented patterns by using a probabilistic model in which coefficients of the probabilistic model are estimated by a parameter estimation method through sample trainings, recognizing characters in different writing patterns by using a multiple-template matching method when performing single character recognition of the stroke combinations, searching for the best segmentation path and conducting post-processing to optimize the recognition results. The present method and device have advantages of simple structure, low hardware requirement, fast recognition speed and high recognition accuracy and can be implemented in an embedded system.

### TECHNICAL FIELD

The present invention relates generally to character input. More specifically, the present invention relates to a handwriting recognition method and corresponding device that may recognize writing-box-free character sequence inputted continuously by user with improved input efficiency.

### BACKGROUND ART

At present, handwriting recognition modules have been widely used in all kinds of electronic devices such as mobile phones. It is convenient for user to interact with the electronic devices. With the handwriting recognition modules, user needn't to learn other character input method by pressing keyboard.

Non Patent Literature 1 (see below) discloses a handwriting recognition method which designs physical feature (off-stroke features) of segmented patterns to recognize a writing-box-free character sequence. In this method, off-stroke information could be obtained from the last sampling point of the previous stroke and the first sampling point of the next stroke, which is represented as the dotted line shown in FIG. 1. The physical information further includes information such as width/height of segmented patterns and handwriting time of the corresponding segmented patterns. In this method, the physical information includes shape features, position features and gap features of the segmented patterns; lengths of strokes; an average distance of off-strokes; an average time of off-strokes; distances of off-strokes; sine and cosine of angles of the off-strokes and off-stroke gaps. This method focuses on off-stroke process from the end point of the previous stroke to the start point of the current stroke and thus recognizes handwriting input.

This handwriting recognition method assumes that even joined-up handwriting occurs between different characters, the distance and time period of off-strokes between characters shall both be larger than those of the off-strokes within the characters. This method also assumes that each stroke distribution fits a normal distribution. Based on such assumptions, this handwriting recognition method calculates segmented-pattern likelihood based on means and variances of the features by using a probabilistic model. Finally, this method determines a best segmentation path by using dynamic programming (DP).

One problem existing in the above Non Patent Literature 1 is that the segmentation of the handwriting character sequence relies upon handwriting time of each stroke. The time period of off-strokes is a very important feature in this method. This method assumes that the larger the time period of off-strokes between segmented patterns is, the higher the segmentation accuracy is. The above assumption is reasonable when user writes at a relatively constant speed. However, during the utilizations, user usually writes at different speeds, for example, writing fast for a while and slowly for a subsequent while. Therefore, if user changes writing speed during handwriting process, it will be very difficult for the method disclosed in Non Patent Literature 1 to accurately segment the handwritings.

Another problem existing in the above Non Patent Literature 1 is that this method only uses geometry features and time features to determine if the segmentation is correct. This method assumes that the distance of off-strokes between characters is larger than the distance of off-stroke between strokes within the characters. However, such an assumption is not always correct. The Non Patent Literature 1 lists several typical examples of segmentation errors as shown in FIG. 2. It can be seen from FIG. 2 that the distance of off-strokes between certain characters is smaller than that between strokes within characters. As it is shown in the first example in FIG. 2, ‘5’ is over segmented due to excessively large gap between strokes within the character. But as it is shown in the second and third examples, when the distance between characters of an inputted character sequence changes dramatically and sizes of the characters are different remarkably, segmentation errors occur.

### CITATION LIST

### Non Patent Literature 1

“Online Character Segmentation Method for Unconstrained Handwriting Strings Using Off-stroke Features” (Source: Hitachi Ltd. in the Tenth International Workshop on Frontiers in Handwriting Recognition, La Baule, France, 2006)

### SUMMARY OF INVENTION

The technical object of the present invention is to provide a handwriting recognition method and device which are able to recognize a character sequence continuously inputted by user in irrespective of writing speed changes.

According to one aspect of the present invention, a handwriting recognition method is proposed to recognize a writing-box free character sequence continuously inputted by user. The method comprises: calculating features relative to single character recognition accuracies of different stroke combinations in the inputted character sequence, which is based on single character recognition results of different stroke combinations and sub-stroke combinations formed by segmenting strokes in the stroke combinations; determining space geometry features of the different stroke combinations according to space geometry relationships of the sub-stroke combinations formed by segmenting strokes in the stroke combinations; determining segmentation reliabilities of respective stroke combinations of the inputted character sequence in different segmented patterns based on the features relative to single character recognition accuracies and the space geometry features; determining segmentation paths based on the segmentation reliabilities, and presenting to user the character sequence recognition results according to the determined segmentation paths.

According to the other aspect of the present invention, a handwriting recognition device is proposed to recognize a writing-box free character sequence continuously inputted by user. The handwriting recognition device comprises: a handwriting input unit configured to collect the character sequence continuously inputted by user; a single character recognition unit configured to recognize different stroke combinations in the character sequence and to obtain single character recognition results; a segmentation unit configured to calculate features relative to single character recognition accuracies of different stroke combinations in the inputted character sequence based on the single character recognition results of different stroke combinations and sub-stroke combinations formed by segmenting strokes in the stroke combinations and determine space geometry features of the different stroke combinations according to space geometry relationships of the sub-stroke combinations, to determine segmentation reliabilities of respective stroke combinations of the inputted character sequence in different segmented patterns based on the features relative to single character recognition accuracies and the space geometry features, and to determine segmentation paths based on the segmentation reliabilities; and a display control unit configured to control a display screen to present user the character sequence recognition results according to the determined segmentation paths.

Because of adopting writing-box free manner, user can continuously input a character sequence so as to improve handwriting input efficiency. As to the input method which requires the user to write each character within each writing-box, intermission between handwriting characters often interrupts the user's thinking to decrease the input speed. The method requiring each character to be written within the prescribed writing-boxes (for example, the commonly two-box input method in current mobile phone requires user to switch between two writing-boxes frequently) also changes handwriting habit of the user and reduces handwriting input efficiency. However, without changing handwriting habit, the method and device according to an embodiment of the present invention allow continuous character sequence input and allow recognition results' output separately or overall.

During calculating the segmentation reliabilities of the character sequence, the method and device of the present embodiment consider that not only the commonly used space geometry features but also the single character accuracy of merged stroke combination and that of sub-stroke combination, as a result, it can achieve correct segmentation in cases that the correct segmentation is difficult to be performed by traditional technology, for example, strokes in different characters are partially overlapping in space, or the stroke gaps in a character is too big.

Moreover, the method and device of the present embodiment do not rely on the input time of each stroke when performing the character sequence segmentation, so it can adapt to different input habits of users. Even a user inputs the character sometimes fast and sometimes slow, the segmentation accuracy will not be decreased according to the method and device of the present embodiment.

In addition, the space geometry features of the stroke combination adopted in the method and device of the present embodiment are normalized features based on the estimated average width or height of characters, so the device of present embodiment can adapt to a character sequence with any size. Since multiple-template training and multiple-template matching methods are adopted in the single character recognition unit, the characters in different writing patterns by different users (e.g., simplified characters of Kanji by Chinese) can be accurately recognized by the method and device of the present embodiment. Furthermore, the method and device of the present embodiment utilize the language model and dictionary matching so that the device has the functions of spell check and word correction.

Finally, the recognition objects of the method and device of the present embodiment can be English word, Japanese kana combination, Chinese sentence, Korean character combination, and etc. The timing of performing handwriting recognition can be designated arbitrarily. The recognition result can be continually updated while the user inputs the character sequence, or the recognition results can be displayed after the user finishes the whole character sequence input.

### BRIEF DESCRIPTION OF DRAWINGS

The foregoing and other objectives, features, and advantages of the invention will be more readily understood upon consideration of the following detailed description of the invention, taken in conjunction with the accompanying drawings.

FIG. 1 illustrates a conventional character recognition method based on off-stroke features.

FIG. 2 illustrates problems occurring when recognizing characters based on the off-stroke features in prior art.

FIG. 3 is a structure schematic diagram illustrating a handwriting recognition device according to an embodiment of the present invention.

FIG. 4 is a flowchart illustrating a sample training process of the handwriting recognition device according to an embodiment of the present invention.

FIG. 5A is a schematic diagram illustrating stroke combinations and their sub-stroke combinations in the handwriting recognition device according to an embodiment of the present invention.

FIG. 5B is a schematic diagram illustrating stroke combinations and their sub-stroke combinations in the handwriting recognition device according to an embodiment of the present invention.

FIG. 5C is a schematic diagram illustrating stroke combinations and their sub-stroke combinations in the handwriting recognition device according to an embodiment of the present invention.

FIG. 5D is a schematic diagram illustrating stroke combinations and their sub-stroke combinations in the handwriting recognition device according to an embodiment of the present invention.

FIG. 6A is a schematic diagram explaining space geometry features of the stroke combinations in the handwriting recognition device according to an embodiment of the present invention.

FIG. 6B is a schematic diagram explaining space geometry features of the stroke combinations in the handwriting recognition device according to an embodiment of the present invention.

FIG. 6C is a schematic diagram explaining space geometry features of the stroke combinations in the handwriting recognition device according to an embodiment of the present invention.

FIG. 6D is a schematic diagram explaining space geometry features of the stroke combinations in the handwriting recognition device according to an embodiment of the present invention.

FIG. 7 is a schematic diagram illustrating different writing patterns for the same character according to an embodiment of the present invention.

FIG. 8 is another schematic diagram illustrating different writing patterns for the same character according to an embodiment of the present invention.

FIG. 9A is a schematic diagram illustrating multiple-template training and multiple-template matching according to an embodiment of the present invention.

FIG. 9B is a schematic diagram illustrating multiple-template training and multiple-template matching according to an embodiment of the present invention.

FIG. 9C is a schematic diagram illustrating multiple-template training and multiple-template matching according to an embodiment of the present invention.

FIG. 10 is a function curve diagram illustrating a Logistic Regression Model according to an embodiment of the present invention.

FIG. 11 is a flowchart illustrating a handwriting recognition procedure according to an embodiment of the present invention.

FIG. 12A is a schematic diagram illustrating segmentations through different segmentation paths according to an embodiment of the present invention.

FIG. 12B is a schematic diagram illustrating segmentations through different segmentation paths according to an embodiment of the present invention.

FIG. 12C is a schematic diagram illustrating segmentations through different segmentation paths according to an embodiment of the present invention.

FIG. 13A is a schematic diagram illustrating handwriting recognition results of the handwriting recognition device according to an embodiment of the present invention.

FIG. 13B is a schematic diagram illustrating handwriting recognition results of the handwriting recognition device according to an embodiment of the present invention.

FIG. 13C is a schematic diagram illustrating handwriting recognition results of the handwriting recognition device according to an embodiment of the present invention.

FIG. 13D is a schematic diagram illustrating handwriting recognition results of the handwriting recognition device according to an embodiment of the present invention.

FIG. 14 is a schematic diagram illustrating an application of the handwriting recognition method according to an embodiment of the present invention on an electronic dictionary.

FIG. 15 is a schematic diagram illustrating candidates of at least a part of recognition results provided to the user for selection and error correction according to an embodiment of the present invention.

FIG. 16A is a schematic diagram illustrating applications of the handwriting recognition method according to an embodiment of the present invention on a notebook computer.

FIG. 16B is a schematic diagram illustrating applications of the handwriting recognition method according to an embodiment of the present invention on a mobile phone.

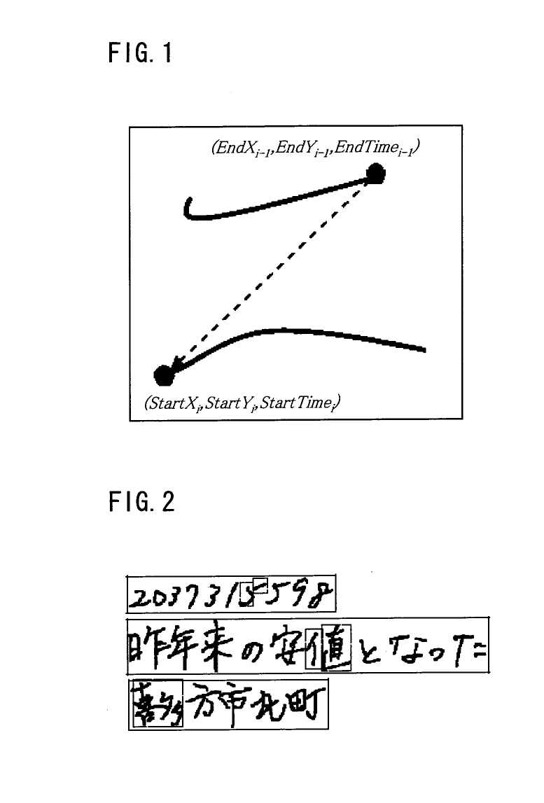

### DESCRIPTION OF EMBODIMENTS

Preferred embodiments will be explained by referring to the accompanying drawings. In the drawings, same reference numerals will be used for indicating same or similar components, although illustrated in different figures. Unnecessary parts and functions for the present invention will be omitted for brevity so as to avoid confusion in understanding.

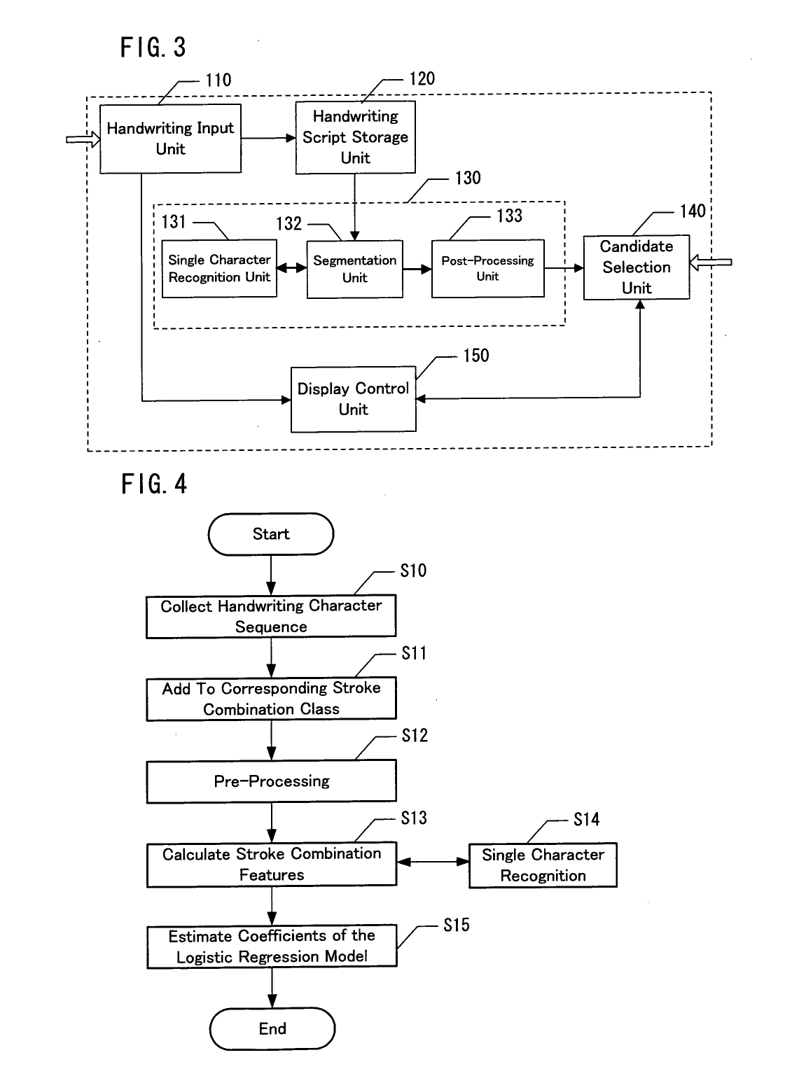

FIG. 3 is a structure schematic diagram illustrating a handwriting recognition device according to an embodiment of the present invention.

As shown in FIG. 3, the handwriting recognition device according to an embodiment of the present invention is used to recognize a writing-box-free character sequence continuously inputted by user. The handwriting recognition device consists of a handwriting input unit 110 for collecting scripts of the user and digitizing it as an input script signal; a handwriting script storage unit 120 for saving the input script signal generated by the handwriting input unit 110 and a character sequence recognition unit 130 for recognizing the inputted character sequence. The character sequence recognition unit 130 consists of three sub-units, segmentation unit 132, single character recognition unit 131 and post-processing unit 133.

Since adopting writing-box-free input, the user can continuously input a character sequence so as to improve handwriting input efficiency. A recognition result will be real-time displayed during the user input procedure. Alternatively, the overall recognition result will be provided after the user inputs the completed sentence. In traditional input methods that require the user to write characters within the writing-box, intermission between handwriting characters often interrupts the user's thinking and decrease the input speed. The method requiring each character to be written within the prescribed writing-boxes (for example the two-box input method commonly used in current mobile phones requires user to switch between two writing-boxes frequently) also changes handwriting habit of user and reduces handwriting input efficiency. However, without changing the handwriting habit, the method and device according to an embodiment of the present invention allow continuous character sequence input and allow recognition results' output separately or overall.

The segmentation unit 132 extracts various space geometry features of respective stroke combinations in the inputted character sequence from the input script signal, obtains single character recognition results and single character recognition accuracies of respective stroke combinations by calling the single character recognition unit 131, then calculates “segmentation reliabilities” based on a Logistic Regression Model and obtains the best N segmented patterns by using an N-best algorithm, which will be described detailedly in the later part.

The post-processing unit 133 corrects the character sequence recognition results of the segmentation unit 132 by utilizing language model and matching dictionary database.

As shown in FIG. 3, the handwriting recognition device according to an embodiment of the present invention further includes a display control unit 150 and a candidate selection unit 140. On the one hand, the display control unit 150 controls the system to display the scripts and present to user on a display screen when the user inputs strokes in the handwriting input unit 110, and on the other hand, the display control unit 150 displays recognition candidates generated by the character sequence recognition unit 130 on the display screen for user selection. The candidate selection unit 140 selects, under the user operation, the character sequence or single character from the corresponding candidates and provides the recognition results to user or provides to other applications, for example, the application of dictionary to explain the recognition results.

According to an embodiment of the present invention, the intercept and the regression coefficients of the Logistic Regression Model utilized in the character sequence recognition unit 130 are estimated by data trainings of the samples.

FIG. 4 is a flowchart illustrating a training process of the handwriting recognition device according to an embodiment of the present invention.

According to an embodiment of the present invention, samples in the data training includes not only single character samples but also each strokes in the characters and a combination of several strokes within a character or a combination of strokes within two different characters. Each of the above samples is defined as one kind of stroke combination.

As shown in FIG. 4, in step S10, handwriting scripts are collected. In Step S11, the collected data are added to a corresponding stroke combination class. Then pre-processing is conducted in Step S12 and stroke combination features are calculated in Step S13.

The features for sample training are the m-dimensional feature (x₁, x₂, . . . , x_{M}) in the Logistic Regression Model. The stroke combination features include a gap between the bounding boxes of the sub-stroke combination, a width of merged sub-stroke combination, a vector and distance between sub-stroke combinations, a single character recognition accuracy of merged sub-stroke combination, a difference between merged recognition accuracy and recognition accuracies of the sub-stroke combinations, a ratio of the first candidate's single character accuracy to other candidate's single character accuracy of the merged sub-stroke combination, and so on.

Before the feature calculation in Step S13, a pre-processing should be performed in Step S12, which estimates a character's average height H_{avg} and character's average width W_{avg} according to heights and widths of the inputted character sequence as a normalization preparation for the space geometry features of the stroke combinations so that the handwriting recognition device according to an embodiment of the present invention could be applied to a character sequence with any size.

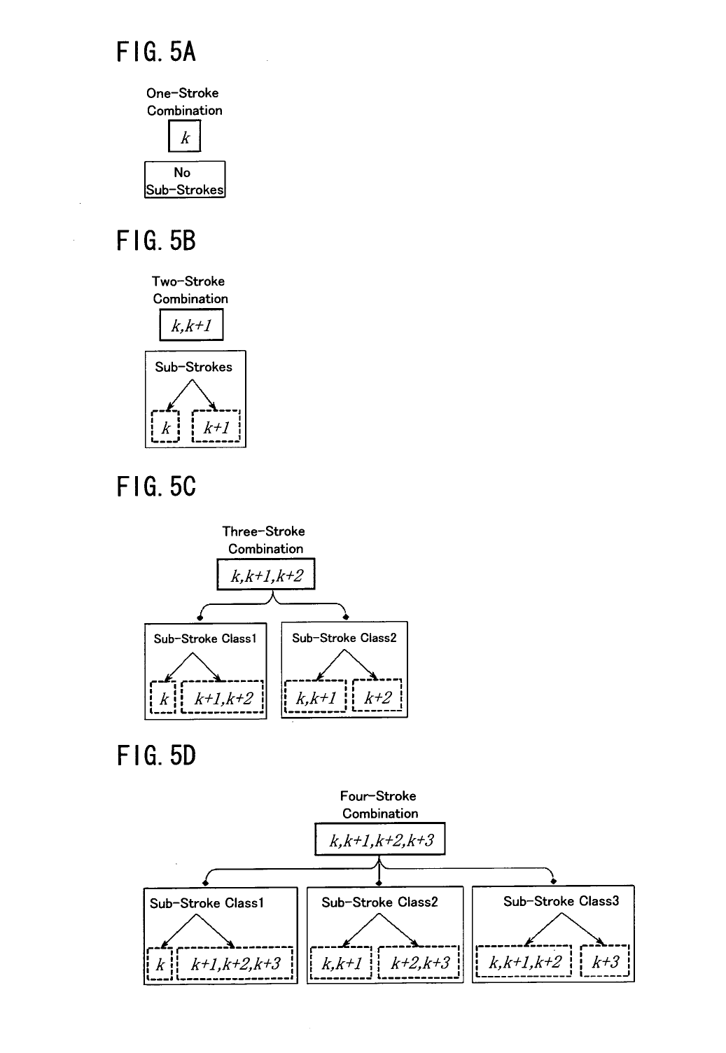

The concept of sub-stroke combination (“sub-stroke” for short hereinafter) according to an embodiment of the present invention will be explained by taking an example of segmentation from the kth stroke to the k+3th stroke in a character sequence. From the kth stroke, there are four possible segmented patterns as shown in FIGS. 5A, 5B, 5C and 5D.

1) one-stroke combination only includes the kth stroke and does not have sub-strokes.

2) two-stroke combination includes the kth and k+1th sub-strokes.

3) three-stroke combination has two sub-stroke classification modes.

Mode 1: the previous sub-stroke is the kth stroke and the next sub-stroke is the stroke combination of the k+1th and k+2th strokes.

Mode 2: the previous sub-stroke is the stroke combination of the kth and k+1th strokes and the next sub-stroke is the k+2th stroke.

4) four-stroke combination has three sub-stroke classification modes.

Mode 1: the previous sub-stroke is the kth stroke and the next sub-stroke is the stroke combination of the k+1th, k+2th and k+3th strokes.

Mode 2: the previous sub-stroke is the stroke combination of the kth and k+1th strokes and the next sub-stroke is the stroke combination of the k+2th and k+3th strokes.

Mode 3: the previous sub-stroke is the stroke combination of the kth, k+1th and k+2th strokes and the next sub-stroke is the k+3th stroke.

It can be seen from the embodiment of the present invention that the sub-stroke combination could be different combinations formed by sequentially segmenting strokes in a certain “stroke combination”. For example, for a stroke combination in a writing order of “k, k+1, k+2”, its sub-stroke combination could be the “Sub-stroke Class 1” generated by segmenting between the strokes “k” and “k+1” or the “Sub-stroke Class 2” generated by segmenting between the strokes “k+1” and “k+2”, as shown in FIG. 5C.

In the device according to an embodiment of the present invention, various features of the stroke combination, including single character recognition accuracy features and space geometry features of the sub-stroke combination, are calculated for all possible stroke combinations in the character sequence. The various detailed features are listed as follows:

(a) a single character recognition accuracy, C_{merge}, of merged sub-strokes: the larger it is, the larger the possibility of merging into a single character is;

(b) a difference, (2*C_{merge}−Cₛₜᵣ₁−Cₛₜᵣ₂), between merge recognition accuracy C_{merge} and single character recognition accuracies, Cₛₜᵣ₁ and Cₛₜᵣ₂, of two sub-strokes. If the difference is larger than 0, it means that a possibility of merging into a single character from the two strokes is larger than a possibility of two sub-strokes being single characters respectively. The larger the difference is, the larger the possibility of merging into a single character is;

(c) a ratio of the first candidate's single character recognition accuracy of the merged sub-strokes (C_{merge}) to other candidate's single character recognition accuracy of the merged sub-strokes (C_{mergeT}) (T represents the Tth candidate of the single character recognition and the value of T can be set): if the ratio is relatively large, it means that a matching distance between the merged stroke combination and the first candidate of the single character recognition is quite near and matching distances between the merged stroke combination and other candidates are far, which indicates that the possibility of merging into a single character is relatively large;

(d) a gap between two bounding boxes of sub-strokes, gap/W_{avg} (or gap/H_{avg}): the smaller the gap of the sub-strokes is, the larger the possibility of forming a single character after merge is. If the gap is a negative value, the possibility of forming a single character after merge is much larger;

(e) a merged sub-stroke width, W_{merge}/W_{avg} (or W_{merge}/H_{avg}): the smaller the merged width is, the larger the possibility of forming a single character is;

(f) a vector, Vₛ₂₋ₑ₁/W_{avg} (or Vₛ₂₋ₑ₁/H_{avg}), between the end sampling point of the previous sub-stroke and the start sampling point of the next sub-stroke;

(g) a distance, dₛ₂₋ₑ₁/W_{avg} (or dₛ₂₋ₑ₁/H_{avg}), between the end sampling point of the previous sub-stroke and the start sampling point of the next sub-stroke;

(h) a distance, dₛ₂₋ₛ₁/W_{avg} (or dₛ₂₋ₛ₁/H_{avg}), between the start sampling point of the previous sub-stroke and the start sampling point of the next sub-stroke.

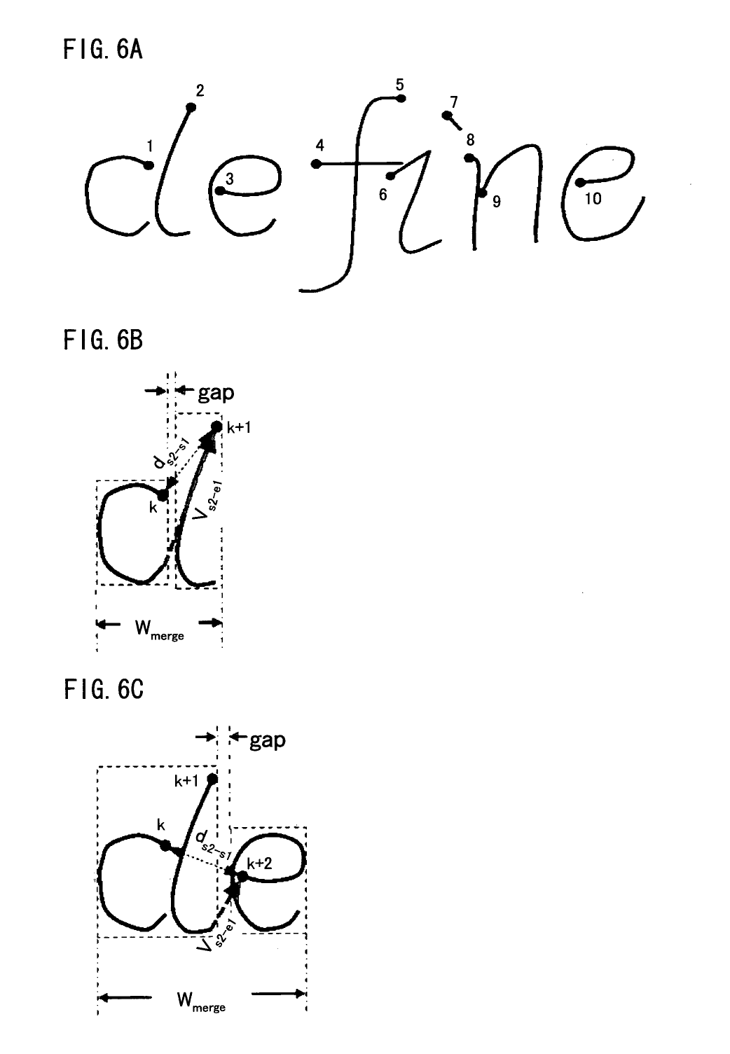

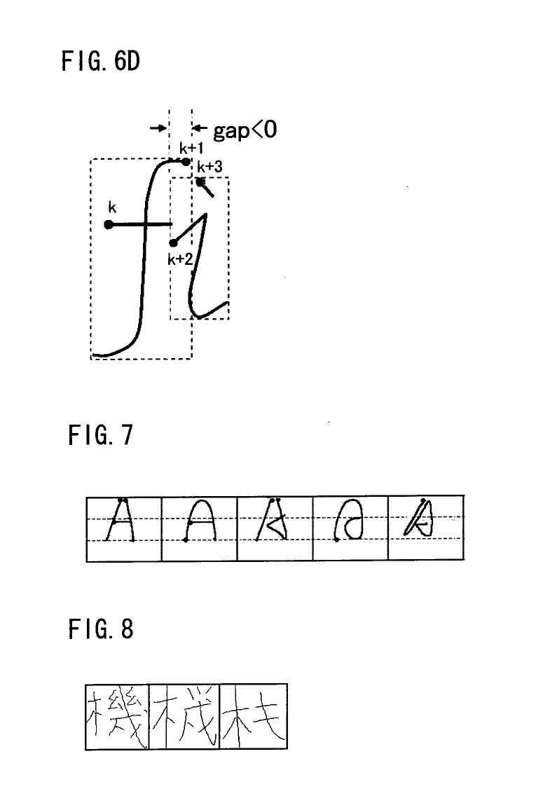

In the above features, “/” represents a division sign, and W_{avg} and H_{avg} represent the estimated character average width and character average height during the pre-processing procedure. The space geometry features of (d)-(h) refer to FIG. 6A-6D and dots in the figures represent a start point of each stroke.

For the above features (a), (b) and (c), the single character recognition accuracy C_{merge} and other candidate accuracy C_{mergeT} of the merged sub-strokes, and single character recognition accuracies, Cₛₜᵣ₁ and Cₛₜᵣ₂, of two sub-strokes are obtained by calling the single character recognition unit in Step S14.

The single character recognition unit according to an embodiment of the present invention adopts a template matching method to recognize the single character. The single character recognition accuracy is determined by the distance of the template matching. The smaller the distance is, the larger the accuracy is. In the sample training of the single character recognition, machine learning algorithms (for example, GLVQ) are adopted to generate feature templates. The single character feature vector includes “stroke direction distribution features”, “grid stroke features” and “peripheral direction features”. Before the feature extraction, pre-processing is conducted, which includes operations such as “isometric smooth”, “centroid normalization” and “nonlinear normalization” so as to regulate the features of the samples. In the template matching, a “multi-stage cascade matching” method is adopted to filter candidates out stages by stages so as to improve matching speed. The above single character recognition method is disclosed in Chinese patent application publication No. CN101354749A and all contents in this application are incorporated into the present invention for reference.

During practical writing procedure, different users may usually write the same character in different writing patterns. For example, an English letter “A” may have a plurality of writing patterns as shown in FIG. 7.

A Japanese kanji “ [symbol] ” may have three writing patterns as shown in FIG. 8, in which the latter two writing patterns are simplified characters.

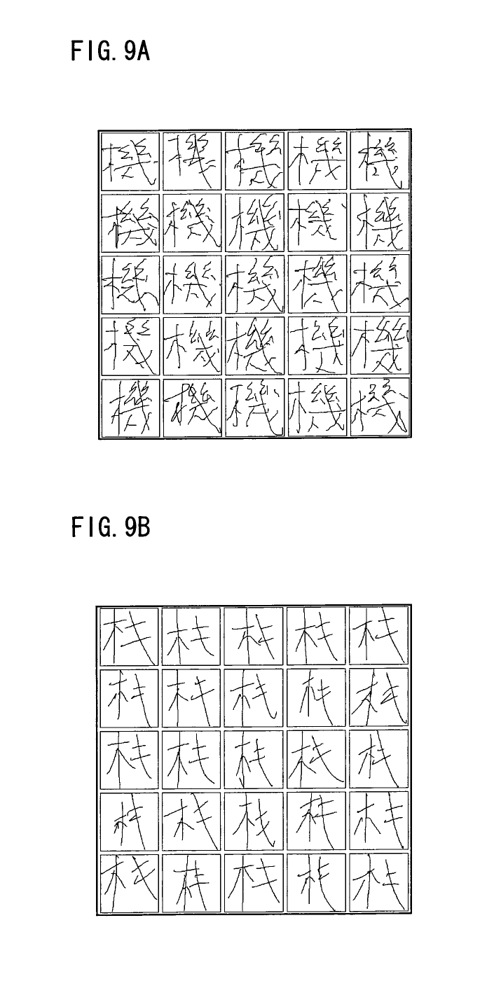

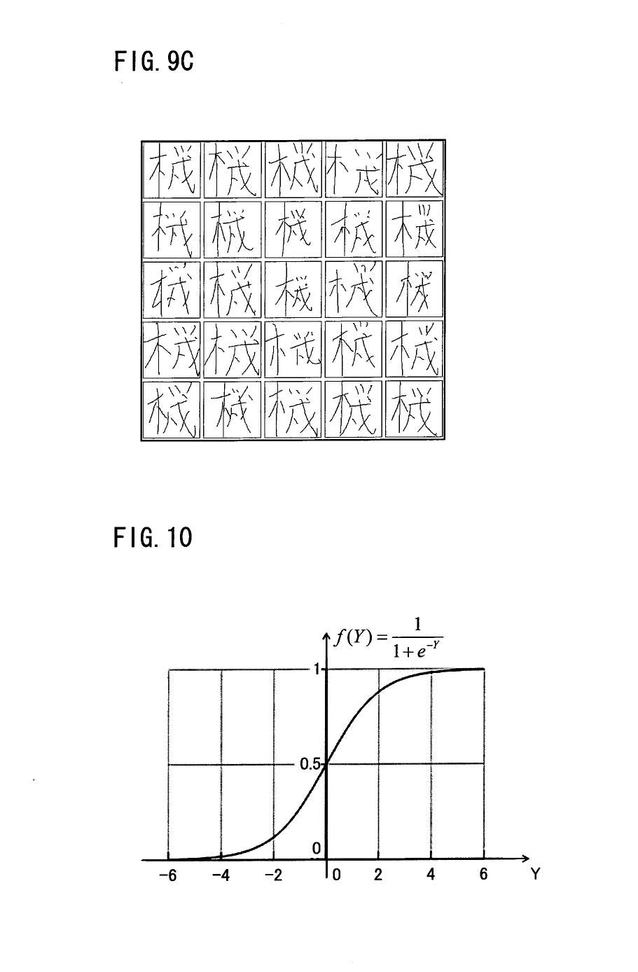

Therefore, in order to improve robustness of the handwriting recognition, a “multiple-template training” method is adopted in the device according to an embodiment of the present invention so as to perform individual training for different writing patterns of the same character so that the “multiple-template matching” method could be used for recognizing characters in various writing patterns. In order to perform the “multiple-template training”, the collected samples are firstly classified according to their different writing patterns. For example, for the above mentioned Kanji “ [symbol] ”, the present embodiment adopts three formats of samples shown in FIGS. 9A, 9B and 9C to form the multiple-template training during the sample training.

As shown in FIG. 4, in Step S15, coefficients of the Logistic Regression Model are calculated. The key of realizing handwriting character sequence's recognition is correctly segmenting the character sequence. The device and method of an embodiment of the present invention calculate segmentation reliabilities of respective stroke combinations of the inputted character sequence in various kinds of segmented patterns according to various features of the inputted character sequence. A segmentation reliability formula of the present embodiment adopts the Logistic Regression Model (LRM) which is:

$$f ( Y ) = \frac{1}{1 + {e}^{- Y}} . \qquad ( 1 )$$

A function curve diagram of the Logistic Regression Model is shown in FIG. 10. When Y changes in a range of −∞˜+∞, a value of f(Y) ranges from 0 to 1, which means that the segmentation reliability ranges from 0% to 100%. When Y=0, f(Y)=0.5, which indicates that the segmentation reliability is 50%.

In the above Logistic Regression Model,

Y=g(X)=β₀+β₁x₁+β₂x₂+ . . . +βₘxₘ (2).

X=(x₁, x₂, . . . , xₘ) is a risk factor of the Logistic Regression Model. When the device and method of the present embodiment calculate the segmentation reliabilities, X=(x₁, x₂, . . . , xₘ) represents as an m-dimensional feature of the stroke combination. (β₀, β₁, β₂, . . . , βₘ) represents an intercept and regression coefficients of the Logistic Regression Model.

After calculating m-dimensional features of all possible stroke combinations in the character sequence, the device and method of the present embodiment adopt a maximum likelihood estimation method (or other parameter estimation methods such as least square estimation method) to estimate the intercept β₀ and regression coefficients (β₁, β₂, . . . , βₘ) of the Logistic Regression Model for the segmentation reliabilities.

Assuming that there are n stroke combination samples and observation values are (Y₁, Y₂, . . . , Yₙ) respectively. For the ith stroke combination, the m-dimensional feature is Xᵢ=(xᵢ₁, xᵢ₂, . . . , xᵢₘ) and the observation value is Yᵢ. N regression relationships may be expressed as:

$$\{ \begin{matrix}{Y}_{1} = {β}_{0} + {β}_{1} {X}_{11} + {β}_{2} {X}_{12} + … + {β}_{m} {X}_{1 m} \\ {Y}_{2} = {β}_{0} + {β}_{1} {X}_{21} + {β}_{2} {X}_{22} + … + {β}_{m} {X}_{2 m} \\ … \\ {Y}_{n} = {β}_{0} + {β}_{1} {X}_{n 1} + {β}_{2} {X}_{n 2} + … + {β}_{m} {X}_{nm} .\end{matrix} \qquad ( 3 )$$

During the sample training, for the ith stroke combination, if the stroke combination is reliable, let

$${f}_{i} = f ( {Y}_{i} ) = \frac{1}{1 + {e}^{- {Y}_{i}}} -> 1 , f ( {Y}_{i} ) > 0.5 , i . e . , {Y}_{i} > 0 ; \qquad ( 4 )$$

if the stroke combination is not reliable (i.e., this stroke combination pattern is not correct), let

$${f}_{i} = f ( {Y}_{i} ) = \frac{1}{1 + {e}^{- {Y}_{i}}} -> 0 ,$$

f(Yᵢ)<0.5, i.e., Yᵢ<0 (5).

Substituting Y=g(X)=β₀+β₁x₁+β₂x₂+ . . . +βₘxₘ into the Logistic Regression Model formula, then

$$f ( Y ) = \frac{1}{1 + {e}^{- Y}} = \frac{1}{1 + {e}^{- g ( X )}} = π ( X ) \qquad ( 6 )$$

is obtained.

Setting pᵢ=P(fᵢ=1|Xᵢ) as a probability of fᵢ=1, then a conditional probability of fᵢ=0 is P(fᵢ=0|Xᵢ)=1−pᵢ. Thus a probability of one observation value is P(fᵢ)=pᵢ^{f}^{ᵢ}(1−pᵢ)^{(1-f}^{ᵢ}⁾.

Since respective observations are independent, their joint distribution can be represented as a product of respective marginal distributions, which is

$$1 ( β ) = {\prod }_{i = 1}^{n} {{π ( {X}_{i} )}^{{f}_{i}} [ 1 - π ( {X}_{i} ) ]}^{1 - {f}_{i}} . \qquad ( 7 )$$

The above equation is called as a likelihood function for n observations. The object is to estimate the parameters which maximize this function value. Therefore, the key of the maximum likelihood estimation is to estimate the most suitable parameters (β₀, β₁, β₂, . . . , βₘ) which maximize the above likelihood function. Taking logarithm to the above likelihood function, then a log-likelihood function is obtained. A derivative of the log-likelihood function is then calculated to get m+1 likelihood equations. Finally, Newton-Raphson method is applied to iteratively calculate these m+1 likelihood equations and thus coefficients (β₀, β₁, β₂, . . . , βₘ) in the Logistic Regression Model can be obtained and can be saved in the device of present embodiment for using in the recognition procedure.

According to another embodiment of the present invention, segmentation reliabilities of the inputted character sequence in respective segmented patterns can also be calculated with a normal distribution model.

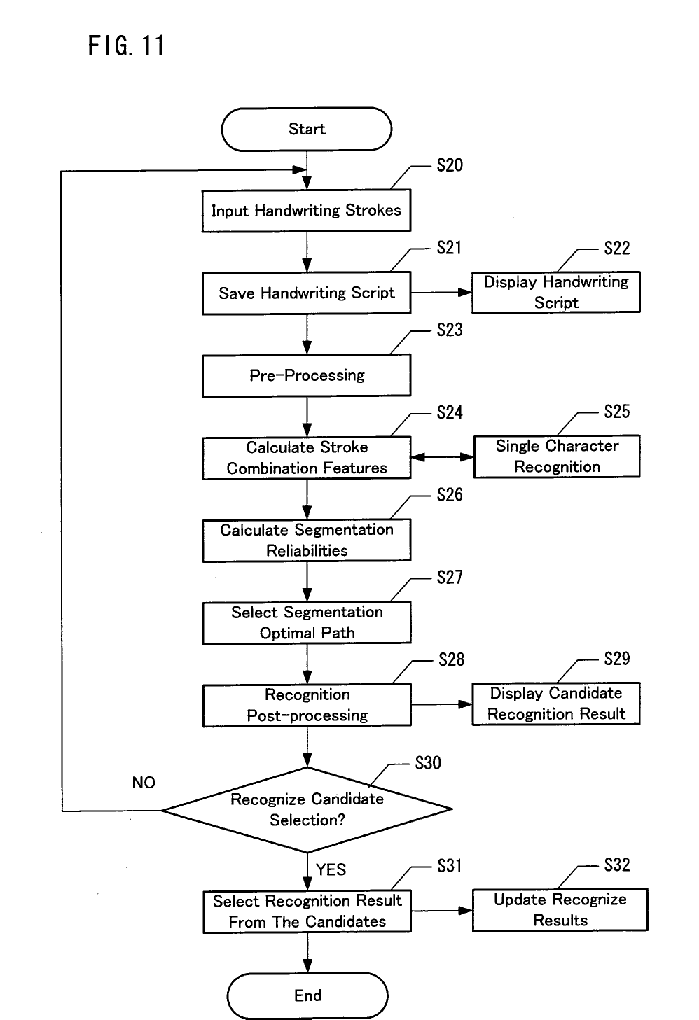

FIG. 11 is a flowchart illustrating a handwriting recognition procedure according to an embodiment of the present invention. As shown in FIG. 11, in Step S20, the user inputs handwriting and the strokes of the character sequence are collected in the handwriting input unit 110. Then in Step S21, collected scripts are saved in the handwriting script storage unit 120 and are displayed in the user interface by the display control unit 150 in Step S22.

Then, for the strokes saved in the script storage unit, the character sequence recognition unit 130 performs operations of “pre-processing”, “stroke combination feature calculation”, “single character recognition”, “segmentation reliability calculation”, “segmentation optimum path selection” and “recognition post-processing” in the Steps S23, S24, S25, S26, S27 and S28 respectively.

In details, execution procedures in Steps S23, S24 and S25 are similar to those steps in the above Logistic Regression Model coefficients estimation by the sample training. In Step S23, a pre-processing is performed to estimate the character's average height H_{avg} and character's average width W_{avg} according to heights and widths of the character sequence as a normalization preparation for the space geometry features of the stroke combination so that the handwriting recognition device according to an embodiment of the present invention could be applied to the character sequence with any size.

In Step S24, various features, including single character recognition accuracy features and space geometry features of the sub-stroke combination, of the stroke combination are calculated for all possible stroke combinations in the character sequence.

In Step S25, the single character recognition unit is called to obtain the single character recognition accuracy C_{merge} and other candidate accuracy C_{mergeT} of the merged sub-strokes, and single character recognition accuracies Cₛₜᵣ₁ and Cₛₜᵣ₂ of two sub-strokes.

In Step S26, by utilizing above formulas (1) and (2) of the Logistic Regression Model, the method according to the present embodiment calculates the segmentation reliabilities f(Y) of respective stroke combinations for the inputted character sequence in various segmented patterns based on the respective features (X=(x₁, x₂, . . . , xₘ)) of the inputted character sequence and coefficients (β₀, β₁, β₂, . . . , βₘ) obtained in the sample training.

In Step S27, the method according to the present embodiment calculates the most possible N segmentation paths using the N-Best method. A start point of each stroke is defined as an element-node and a path consisting of the element-node or an element-node combination is a corresponding stroke combination. A cost function for each partial path is C(Y)=1−f(Y), in other words, the higher the segmentation reliability is, the smaller the value of the cost function for the partial path is. The N-Best method is used to select the best N paths which make the sum of the values of the cost function for all passed paths to be the least, second least, . . . . Nth least.

The N-Best method can be implemented by various means, for example, multiple candidates can be generated by combining dynamic programming (DP) method and stack algorithms. In the present embodiment, the N-Best method includes two steps: forward search and backward search. The forward search adopts an improved Viterbi algorithm (Viterbi algorithm is a dynamic programming method for searching the most possible implicit state sequence) for recording states of the best N partial paths transferred to each element-node (i.e., a sum of cost function values of passed paths) and the state of the kth element-node is only relative to the state of the k-1th element-node. The backward search is a stack algorithm based on the A* algorithm. A heuristic function for each node k is a sum of two functions, a “path cost function” which represents the sum of the cost function value for the shortest path from the start point to the kth node and a “heuristic estimation function” which represents the estimation of the path cost from the kth node to the target node. In the backward search, a path score in the stack is a full-path score and the optimal path always locates in the stack top. Thus, this algorithm is a global optimum algorithm.

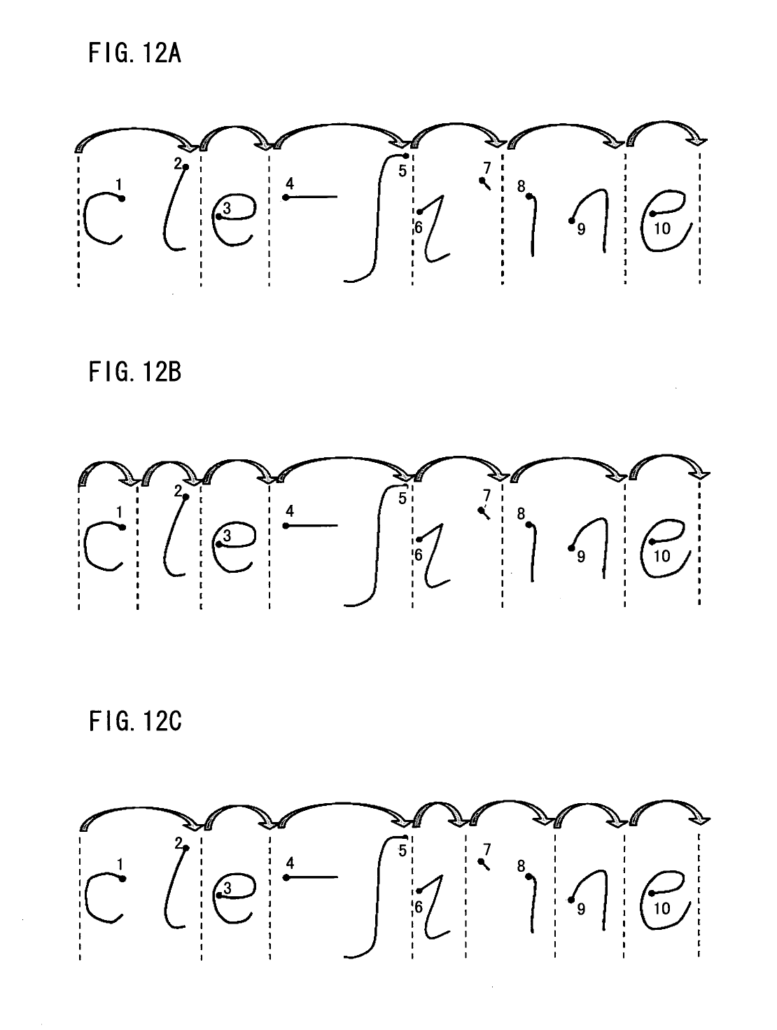

Assuming that the user has inputted a handwriting character sequence “define” as shown in FIG. 6A, FIG. 12A illustrates a segmentation result for the handwriting character sequence according to an embodiment of the present invention. Three most possible segmented patterns by the N-Best method are illustrated in FIG. 12A, FIG. 12B and FIG. 12C respectively. The first candidate of single character recognition result for each character in the first segmented pattern is “define (i.e., correct answer)”, the first candidate in the second segmented pattern is “ccefine” and the first candidate in the third segmented pattern is “deftine”.

In Step S28, finally the method of the present embodiment performs post-processing and corrects errors (e.g., spelling mistake of the English word) for the recognition results by matching with the dictionary (English word dictionary) or using language model (for example, bigram model).

In Step S29, the display control unit 150 controls the display screen to present the handwriting recognition results and the relative candidates to user so that user can select or confirm the displayed recognition results in the candidate selection unit 140 (default recognition result is the first candidate of single character recognition for each character in the first segmented pattern). The user can select the correct segmented pattern from candidate segmented patterns of the character sequence or can select the correct recognition results from candidates of respective characters to manually correct a part of recognition result in the character sequence, for example, clicking a single character or a phrase to select the recognition result from their corresponding candidates. FIG. 15 is a schematic diagram illustrating the candidates of the clicked single character which is provided to user for selecting and correcting according to an embodiment of the present invention.

Step S30 detects whether the user has confirmed or selected a certain candidate. If the user continues writing without confirming or selecting any candidate, the process goes to Step S20 and continues the above recognition processing. If it has detected that a certain candidate has been selected, Step 31 selects the recognition result from the candidates and displays the recognition result or provides to other applications. At the same time, the recognition result of the handwriting input is updated in Step S32.

During calculating the segmentation reliability of the character sequence, the method and device of the present embodiment consider, not only the commonly used space geometry features but also the single character recognition accuracy of the merged stroke combination and the single character recognition accuracies of the sub-stroke combinations, as a result, it can achieve correct segmentation and recognition result in cases that the correct segmentation is difficult to be performed by traditional technology, for example, strokes in different characters are partially overlapping in space, or the stroke gaps in a character is too big.

Moreover, the method and device of the present embodiment do not rely on the input time of each stroke when performing the character sequence segmentation, so it can adapt to different input habits of users. Even a user inputs the character sometimes fast and sometimes slow, the segmentation accuracy will not be decreased according to the method and device of the present embodiment.

In addition, the space geometry features of the stroke combination adopted in the method and device of the present embodiment are normalized features based on the estimated average width or height of characters, so the device of present embodiment can adapt to a character sequence with any size. Since the multiple-template training and multiple-template matching methods are adopted in the single character recognition, the characters in different writing patterns by different users (e.g., simplified characters of Kanji by Chinese) can be accurately recognized by the method and device of the present embodiment. Furthermore, the method and device of the present embodiment utilize the language model and dictionary matching so that the device has the functions of spell check and word correction.

Finally, the recognition objects of the method and device of the present embodiment can be English word, Japanese kana combination, Chinese sentence, Korean character combination, and etc. The timing of performing handwriting recognition can be designated arbitrarily. The recognition result can be continually updated while the user inputs the character sequence, or the recognition results can be displayed after the user finishes the whole character sequence input.

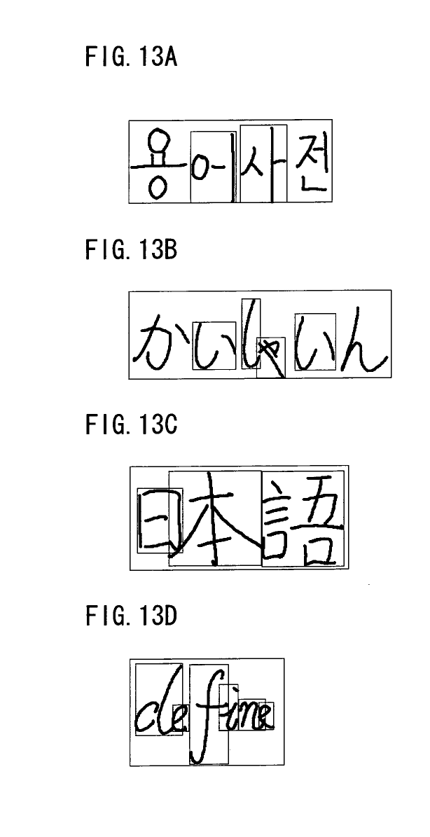

FIGS. 13A, 13B, 13C and 13D are schematic diagrams illustrating handwriting recognition results of the handwriting recognition device according to an embodiment of the present invention. Not only the space geometry features of the stroke combination but also the single character recognition accuracies are considered during the recognition process, as a result, the method of the present embodiment can achieve correct recognition in cases that the traditional technology is difficult to perform correct segmentation, for example, strokes in different characters are partially overlapping in space, or the distance between characters is smaller than the distance between strokes in a character, or font sizes are being different during the handwriting input. For example, as shown in FIG. 13D, the strokes of “d” and “e” and the strokes of “f” and “i” partially overlap in space. As shown in FIG. 13A and FIG. 13C, the gap between “ [symbol] ” and “ [symbol] ” is smaller than the inter-stroke distance within “ [symbol] ” and the gap between “ [symbol] ” and “ [symbol] ” is smaller than the inter-stroke distance within “ [symbol] ”. As shown in FIGS. 13B and 13D, font sizes of characters in “ [symbol] [symbol] ” and “define” are different from each other. The method according to the embodiment of present invention can perform correct recognition in the above cases.

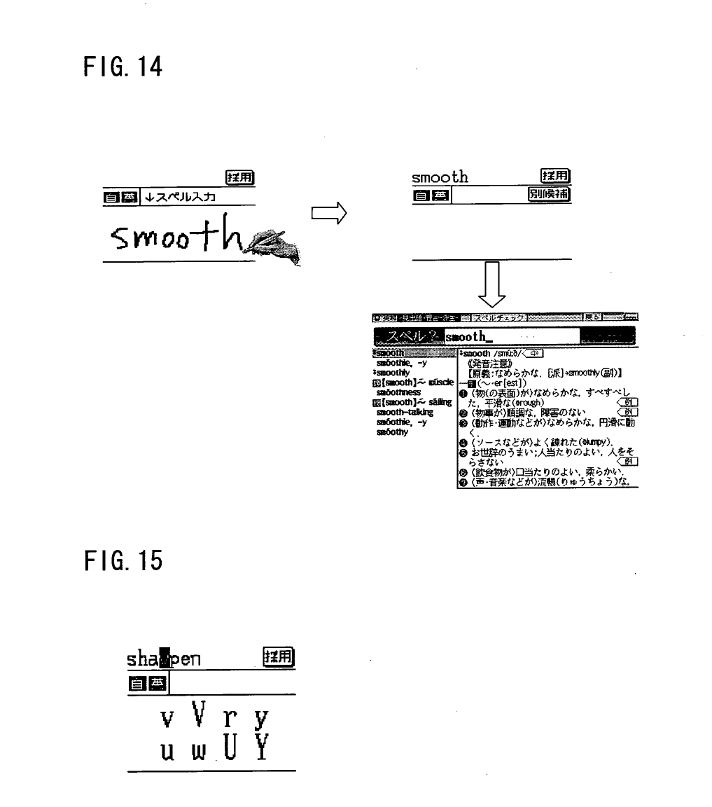

FIG. 14 illustrates an electronic dictionary according to an embodiment of the present invention. As shown in FIG. 14, a series of English handwriting characters are recognized and the recognition results are displayed. Japanese translation of the inputted handwriting is presented to user by looking up the recognized English word in an English-Japanese dictionary. As shown in FIG. 15, when user clicks a certain single character from the recognition result, candidates of this single character will be provided to the user for correction.

Briefly speaking the present embodiment can allow user to perform overall correction for the recognition result of the whole character sequence, and also can allow user to correct any single character recognition result.

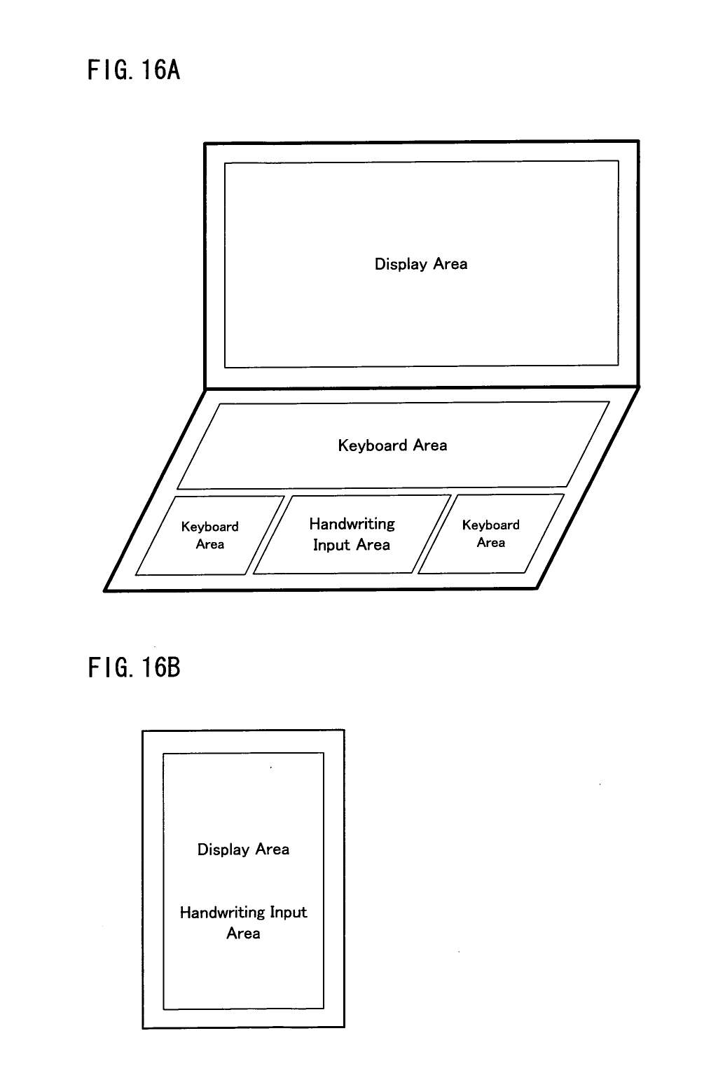

According to another embodiment of the present invention, the display area and the handwriting input area can be configured on different planes or on the same plane as shown in FIGS. 16A and 16B. For example, the handwriting area for the notebook computer can be configured on the plane where the keyboard locates.

As described above, the method and device of the present invention can be applied to or be incorporated into any terminal product which is able to adopt handwriting as input or control manner, for example, personal computer, laptop, PDA, electronic dictionary, MFP, mobile phone, handwriting device with large touching screen, and etc.

The description and drawings only illustrate the principle of the present invention. It shall be noted that those skills in the art could achieve different structures, although these different structures are not clearly described and indicated but these structures embody the principle of the present invention and shall be included within the spirit and scope of the present invention. In the above descriptions, multiple examples are described aiming at respective steps. Although the inventor exerts himself to explain relative examples, it does not mean that these examples should have corresponding relationship according to the representing numerals. As long as there is no contradiction between conditions limited in the selected examples, examples with un-corresponding representing numerals may constitute a technical solution and such technical solution shall be considered as being encompassed by the present invention.

It is to be understood that the claims are not limited to the precise configuration and components illustrated above. Various modifications, changes and variations may be made in the arrangement, operation and details of the systems, methods, and devices described herein without departing from the scope of the claims.

1. A handwriting recognition method for recognizing a character sequence continuously inputted by a user, comprising:
calculating features relative to single character recognition accuracies of different stroke combinations in the inputted character sequence based on single character recognition results of different stroke combinations and sub-stroke combinations formed by segmenting strokes in the stroke combinations;
determining space geometry features of the different stroke combinations according to space geometry relationships of the sub-stroke combinations formed by segmenting strokes in the stroke combinations;
determining segmentation reliabilities of respective stroke combinations of the inputted character sequence in different segmented patterns based on the features relative to single character recognition accuracies and the space geometry features;
determining segmentation paths based on the segmentation reliabilities, and
presenting character sequence recognition results according to the determined segmentation paths to the user.

2. The method of claim 1, wherein a multiple-template matching method is adopted to recognize characters in different writing patterns for obtaining the single character recognition results.

3. The method of claim 1, further comprising:
performing post-processing of the character sequence recognition by using a dictionary database or a language model.

4. The method of claim 1, wherein the features relative to the accuracies of single character recognition comprise at least one of a single character recognition accuracy of a merged sub-stroke combination, a difference between the single character recognition accuracies of the merged sub-stroke combination and the sub-stroke combinations, and a ratio of the first candidate's single character accuracy to the other candidate's single character accuracy of the merged sub-stroke combination, and
the space geometry features of the stroke combinations comprise at least one of a gap between bounding boxes of the sub-stroke combinations, a width of the merged sub-stroke combination, a vector between the end point of the previous sub-stroke combination and the start point of the next sub-stroke combination, a distance between the end point of the previous sub-stroke combination and the start point of the next sub-stroke combination, and a distance between the start point of the previous sub-stroke combination and the start point of the next sub-stroke combination.

5. The method of claim 1, wherein determining the segmentation reliabilities comprises calculating segmentation reliabilities of respective stroke combinations of the inputted character sequence in different segmented patterns by using a Logistic Regression Model.

6. The method of claim 5, wherein the risk factors of the Logistic Regression Model are various kinds of features of stroke combinations.

7. The method of claim 5, wherein an intercept and regression coefficients of the Logistic Regression Model are estimated by sample trainings.

8. The method of claim 1, wherein determining segmentation reliabilities comprises calculating segmentation reliabilities of the inputted character sequence in different segmented patterns by a normal distribution model based on features of the inputted character sequence.

9. The method of claim 1, wherein determining segmentation paths based on the segmentation reliabilities comprises calculating the segmentation paths by using an N-best method or a dynamic programming method.

10. The method of claim 1, wherein presenting character sequence recognition results comprises presenting to the user the character sequence recognition results and at least a part of candidates of the character sequence recognition results.

11. The method of claim 10, wherein in response to a selection of candidate segmented patterns, the character sequence recognition results in the selected segmented pattern are presented to the user.

12. The method of claim 10, wherein in response to a selection of a single character, the character sequence recognition results including the selected single character are presented to the user.

13. A handwriting recognition device for recognizing a character sequence continuously inputted by a user, comprising:
a handwriting input unit configured to collect the character sequence continuously inputted by the user;
a single character recognition unit configured to obtain single character recognition results by recognizing different stroke combinations in the character sequence;
a segmentation unit configured to calculate features relative to single character recognition accuracies of different stroke combinations in the inputted character sequence based on the single character recognition results of the different stroke combinations and sub-stroke combinations formed by segmenting strokes in the stroke combinations, to determine space geometry features of the different stroke combinations according to space geometry relationships of the sub-stroke combinations, to determine segmentation reliabilities of respective stroke combinations of the inputted character sequence in different segmented patterns based on the features relative to single character recognition accuracies and the space geometry features, and to determine segmentation paths based on the segmentation reliabilities, and
a display control unit configured to control a display screen to present to the user the recognition results of the character sequence according to the determined segmentation paths.

14. The device of claim 13, wherein the single character recognition unit recognizes characters in different writing patterns by using a multiple-template matching method.

15. The device of claim 13, further comprising:
a post-processing unit configured to perform the post-processing of the character sequence recognition by using a dictionary database or a language model.

16. The device of claim 13, wherein the features relative to the accuracies of single character recognition comprise at least one of a single character recognition accuracy of a merged sub-stroke combination, a difference between the single character recognition accuracies of the merged sub-stroke combination and the sub-stroke combinations, and a ratio of the first candidate's single character accuracy to the other candidate's single character accuracy of the merged sub-stroke combination, and
the space geometry features of the stroke combinations comprise at least one of a gap between bounding boxes of the sub-stroke combinations, a width of the merged sub-stroke combination, a vector between the end point of the previous sub-stroke combination and the start point of the next sub-stroke combination, a distance between the end point of the previous sub-stroke combination and the start point of the next sub-stroke combination, and a distance between the start point of the previous sub-stroke combination and the start point of the next sub-stroke combination.

17. The device of claim 13, wherein the segmentation unit calculates segmentation reliabilities of respective stroke combinations of the inputted character sequence in different segmented patterns by using a Logistic Regression Model.

18. The device of claim 13, wherein the segmentation unit calculates segmentation reliabilities of the inputted character sequence in different segmented patterns by a normal distribution model based on features of the inputted character sequence.

19. The device of claim 13, wherein the segmentation unit calculates the segmentation paths by using an N-best method or a dynamic programming method.

20. The device of claim 13, wherein the display control unit further controls the display screen to present to the user the character sequence recognition results and at least a part of candidates of the character sequence recognition results.

21. The device of claim 20, wherein in response to a selection of candidate segmented patterns, the display control unit controls the display screen to present the character sequence recognition results in the selected segmented pattern to the user.

22. The device of claim 20, wherein in response to a selection of a single character, the display control unit controls the display screen to present the character sequence recognition results including the selected single character to the user.

23. The device of claim 17, wherein risk factors of the Logistic Regression Model are various features of stroke combination.

24. The device of claim 17, wherein an intercept and regression coefficients of the Logistic Regression Model are estimated by sample trainings.
